(19) United States
(12) Patent Application Publication
(10) Pub. No.: US 2008/0247942 A1
(43) Pub. Date: Oct. 9, 2008

(54) Method and Reactor for Carrying Out Endothermic Catalytic Reactions

(75) Inventors: Bernd Kandziora, Baierbrunn (DE); Ulrich Lahne, Deisenhofen (DE); Helge Moebus, Ebenhausen (DE); Harald Ranke, Poecking (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 11/913,550

(22) PCT Filed: Apr. 27, 2006
(86) PCT No.: PCT/EP06/03943

§ 371 Date: Jun. 2, 2008

(30) Foreign Application Priority Data
May 4, 2005 (DE) 10 2005 020 943.2

(51) Int. Cl. C01B 3/26; B01J 19/00

(52) U.S. Cl. 423/651; 422/198

(57) ABSTRACT

A method and device for the endothermic catalytic reaction of a supply flow is disclosed. The supply flow is divided into at least two partial flows that are parallelly guided through reactor tubes, which are situated inside the combustion chamber of a reactor and which are at least partially filled with a catalyst material or of a catalytically active structured packing or the interior thereof is at least partially surface-coated with a catalytically active material. The partial flows are guided inside a number of passages in the reactor tubes through the combustion chamber inside of which suitable burners guarantee an intense circulation of the combustion chamber atmosphere.

### BACKGROUND AND SUMMARY OF THE INVENTION

This application claims the priority of International Application No. PCT/EP2006/003943, filed Apr. 27, 2006, and German Patent Document No. 10 2005 020 943.2, filed May 4, 2005, the disclosures of which are expressly incorporated by reference herein.

The invention relates to a method for endothermic catalytic conversion of a feedstream, whereby the feedstream is divided into at least two substreams which pass in parallel through reactor tubes arranged in the furnace space of a reactor which is packed at least partially with a packing of catalyst material or a catalytically active structured packing or surface-coated on the inside with a catalytically active material; it also relates to a device for performing the method.

Methods and devices for endothermic catalytic conversion of feedstreams such as stream reforming of hydrocarbons for generating synthesis gas have long been known in the state of the art. A mixture of hydrocarbons and water vapor is passed through a reactor (reformer) and is converted mainly to hydrogen and carbon monoxide.

The reformers are mainly top-fired, side-fired or bottom-fired tubular furnaces designed for high production capacities (several 1000 m³ [STP]/h hydrogen) preferably in a box design; the pot shape is also state of the art for small capacities. The outer shell of a reformer consists of a sheet metal jacket which is provided with a refractory inner lining composed of multiple layers surrounding the furnace space for thermal insulation. The furnace space has reactor tubes passing through it, their internal surface being catalytically active or being packed entirely or at least partially with a packing of a suitable catalyst material or a catalytically active structured packing in the area of the furnace space. A reaction of the starting materials in an endothermic chemical reaction takes place in the reactor tubes. In the case of bottom-fired and top-fired tubular ovens, turbulent free jet burners with forced air feed are used. The off gases, which are passed along the reactor tubes, transfer most of the heat required for the reaction very effectively through radiation to the reactor tubes along a relatively short distance; the remaining heat is transferred by convection. In the case of side-fired tubular ovens, burners of a different type are used, with different flame shapes with which the side walls of the furnace space are heated. The transfer of heat to the reactor tubes in these cases takes place primarily through radiation from the hot furnace space walls but also through convection. After venting from the furnace space, more energy is withdrawn from the cooled off-gases in heat exchangers, e.g., for preheating the feedstream or to generate process steam, so that ultimately the off-gases are directed out of the system through a flue at a temperature of only approx. 200° C.

The reactor tubes are mounted in such a way that their ends protrude beyond the outer sheet metal jacket and/or the furnace space insulation. The feedstream is passed over a distributor and divided into several substreams, which are then sent to the reactor tubes on one side of the reformer. On the other side of the reformer, the ends of the reactor tubes are interconnected via a collector by means of which the reformed gas (product stream) is discharged from the reformer and optionally sent for further processing.

Steam reforming of hydrocarbons takes place of temperatures of approx. 900° C. and at an elevated pressure. In order to be able to ensure a high degree of reliability under these conditions, tubes that are produced from nickel-based alloys by the spin casting method are used. Since such tubes are expensive and constitute a significant portion of the investment costs for a steam reformer, the goal is to implement a given production performance with the smallest possible number of reactor tubes.

At the same time, using a smaller number of tubes means that the inlet distributor and the outlet collector will have simpler designs and therefore can be manufactured at a lower cost. Since fewer tubes in the furnace space mean less mutual “shadowing,” heat can also be transferred better to the reactor tubes through radiant heating when there is a reduction in the number of tubes.

The flow cross section for the feedstream is calculated for a tubular oven as the sum of the cross sections of all reactor tubes. Therefore, with a smaller number of tubes—with the same inside diameters of the tubes—the gas velocity in the reactor tubes increases. The transfer of reaction heat from the furnace space is improved but at the same time the pressure drop across the reformer also increases. For economic reasons, this pressure drop should not exceed a limit value, which is typically between 1.5 and 5 bar. Another effect causing the pressure drop to increase when there is a reduction in the number of reactor tubes is the increase in tube lengths. This is necessary because the quantity of catalyst, which is proportional to the production capacity and is largely independent of the velocity of flow in the reactor tubes, must be distributed among fewer tubes.

In practice, lengths of approx 12 meters or more have proven appropriate for the reactor tubes in reformers for large production capacities. The resulting design heights usually do not allow production of such reformers in factory production and then transporting them to their installation site. Instead, on-site production at a high cost is hardly avoidable.

Therefore, the object of the present invention is to design a method of the type defined in the introduction as well as a device for implementing the method, so that the profitability of endothermic catalytic conversion of feedstreams is improved in comparison with the state of the art.

With regard to the process, this object is achieved according to this invention by the fact that each of the substreams completely or partially crosses the furnace space in the interior of a reactor tube in at least two passes, with the directions of flow in two successive passes being directed essentially in opposite directions, and the furnace space being heated by at least one burner in a manner such that intense circulation of the furnace space atmosphere is ensured.

On its path from one end of a reactor to the other, the direction of flow of each substream is reversed at least once, so it is possible to speak of multiple passes in which each substream is guided past the furnace space. In the passes, which expediently differ only slightly in length, the substreams are preferably directed through straight parallel tube segments that are interconnected by a suitable tube bend. The passes preferably run vertical, with the substreams in the first pass going from top to bottom or from bottom to top. In this way it is possible to greatly reduce the structural height of a reactor in comparison with the state of the art at the same production output. For example, the structural height is reduced almost by half in the case of a two-pass design. The substreams are passed through the furnace space in the reactor tubes in such a way that they are deflected within the furnace space (internal) and/or outside of the furnace space (external).

The furnace space is preferably heated by burners whose off-gases have a high exit momentum (high-speed burners) and which are arranged on the bottom and/or top and/or side walls of the furnace space. In conjunction with special baffles and a suitable burner arrangement, a high turbulence is achieved along with guidance of the off-gases (furnace space atmosphere) so that a homogeneous temperature field with largely moderate gradients develops throughout the entire furnace space. The reactor rubes may be arranged at a slight distance from one another in the furnace space because the amount of reaction heat which is transferred through the radiant heating of the hot burner flame is reduced in comparison with the state of the art and shadowing of the reactor tubes among one another therefore has hardly any interfering effect. The high turbulence leads to a more effective heat transfer from the off-gases to the reactor tubes. Therefore, the surface of the reactor can be reduced at the same output and the reactor can be designed to be more compact.

Temperature differences in the furnace space lead to sagging of the reactor tubes. To prevent the reactor tubes from coming in contact with one another, they are therefore installed at a certain safety distance in the furnace space. The lower the temperature differences, the smaller this safety distance may be. This effect also makes it possible to manufacture the reactor, so that it is more compact and thus less expensive. At the same time, the lifetime of the reactor tubes is increased because smaller temperature differences in the furnace space also result in lower mechanical stresses in the reactor tubes.

The invention also relates to a device for endothermic catalytic conversion of a feedstream, whereby the feedstream is divided into at least two substreams which are passed in parallel through reactor tubes arranged in the furnace space of a reactor, the reactor being filled at least partially with a packing of catalyst material or catalytically active structure packing or surface-coated at least partially on the inside with a catalytically active material.

In terms of the device, the object formulated is achieved according to this invention by the fact that each of the reactor tubes is shaped in such a way that the substreams can be directed in at least two passes entirely or partially through the furnace space, whereby the directions of flow of two successive passes run essentially in opposite directions from one another and the furnace space is equipped with at least one burner which ensures intense circulation of the furnace space atmosphere.

The reactor tubes preferably consist of at least two straight tube segments which are joined together by suitable connecting tubes. The straight tube segments are especially preferably designed with the same diameters. The straight tube segments are packed entirely or partially with a packing of a suitable catalyst material or they are provided with a surface coating of a catalytically active material on the inside.

According to one embodiment of the inventive device, the reactor tubes are arranged in suspension in the furnace space, whereas another embodiment provides for a standing arrangement. In the case of an embodiment of the reactor tubes with two straight tube segments in a suspended arrangement, the tube bends are expediently situated inside the furnace space. In the case of a standing arrangement, one tube bend preferably connects the two straight tube segments outside of the furnace space.

For heating the furnace space, the inventive device is preferably equipped with at least one burner, the off-gases of which enter the furnace space with a high momentum. The burners are expediently arranged on the bottom and/or the top and/or the side walls of the furnace space. The furnace space preferably contains baffles which, in combination with the high off-gas velocities, lead to a high turbulence in the furnace space atmosphere. These are expediently tubular designs through which the combustion gases are forced to pass and which at the same time limit the free flow cross section for the off-gases.

According to another embodiment of the inventive device, the furnace space is heated with special regenerative or recuperative burners which produce intense circulation of the furnace space atmosphere. Not only are combustion gas and oxidizing agent (e.g., air) introduced into the furnace space through the burner heads, but also hot off-gases are removed from the furnace space. A central vent for the off-gases is not provided in this embodiment of the invention.

### BRIEF DESCRIPTION OF THE DRAWINGS

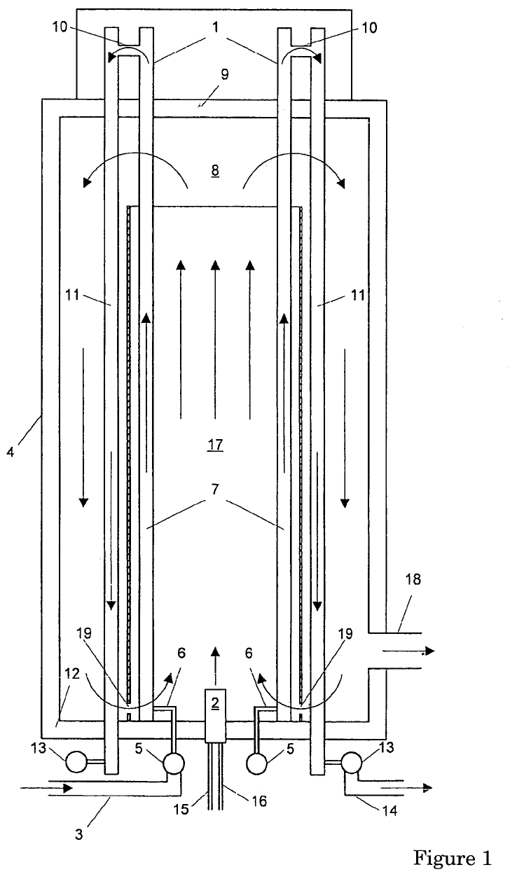

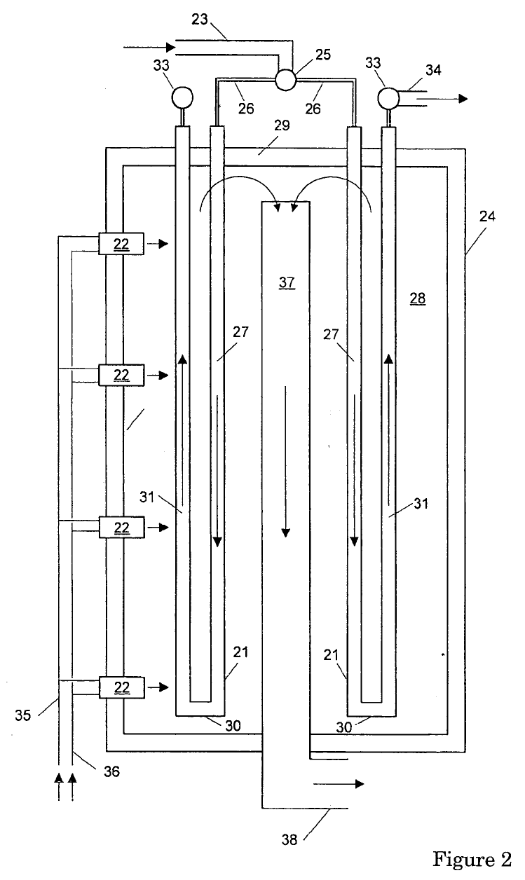

The present invention is explained in greater detail below on the basis of two exemplary embodiments which are diagramed schematically in FIGS. 1 and 2.

### DETAILED DESCRIPTION OF THE DRAWINGS

The first exemplary embodiment relates to a reformer for production of 2500 m³ [STP]/h hydrogen by steam reforming of methane (CH₄). Twelve reactor tubes 1 standing vertically upright are arranged in a circle around a central high-speed burner 2. FIG. 1 shows a section along the longitudinal axis of the reactor, only two of the reactor tubes 1 of which are shown here for the sake of simplicity.

The feedstream consisting of CH₄ and water vapor is supplied to the reformer 4 through line 3. In the distributor 5, it is divided into twelve substreams 6 and distributed among the reactor tubes 1, which are packed with a suitable catalyst material. In the first pass 7, each of the substreams 6 flows vertically upward in the straight tube segments and leaves the cylindrical furnace space 8 through its top 9. Outside of the furnace space 8, each substream 6 is sent through a connecting tube 10 to a second pass 11, which also runs in a straight tube segment but runs vertically downward through the entire furnace space 8. At the end of the reactor tubes 1, which lead out of the furnace space 8 and through the furnace space bottom 12, the substreams 6 are combined by the collector 13 and removed as synthesis gas through the line 14.

The high-speed burner 2, which is arranged centrally on the bottom of the reformer 4 and is supplied with combustion gas and air through lines 15 and 16, fires vertically upward into the furnace space 8. Its off-gases, which produce an intense turbulence in the furnace space atmosphere because of their high outlet velocities, are sent vertically upward in the direction of the first pass 7 through the tube 17, which is also arranged centrally. They are deflected between the top 9 of the furnace space 8 and the top end of the tube 17, then flow from top to bottom in the direction of the second pass 11 before being removed from the reactor 4 through line 18 and/or flowing back to the inside of the tube 17 through openings 19, thereby creating a gas circulation in the furnace space 8. The reactor tubes 1 are arranged in such a way that the substreams 6 flow mostly along the inside of the tube 17 in their first passes 1 and flow mostly along the outside of the tube 17 in their second passes 11. The tube 17 restricts the flow cross section for the combustion gases and thereby increases their velocity of flow and turbulence. This results in very effective transfer of the reaction heat by convection from the hot combustion gases to the reactor tubes.

The second exemplary embodiment also relates to a reformer for production of 2500 m³ [STP]/h hydrogen by steam reforming of methane (CH₄). Twelve reactor tubes 21 suspended from the top 29 of the furnace space 28 are arranged around a central tube 37 and are heated by eight burners 22 arranged in four levels. FIG. 2 shows a section along the longitudinal axis of the reactor in which, for the sake of simplicity, only two of the reactor tubes 21 and four of the burners 22 have been shown.

The feedstream comprised of CH₄ and water vapor is supplied to the reformer 24 through the line 23. In the distributor the feedstream is divided into 12 substreams 26 and distributed among the reactor tubes 21 that are packed with a suitable catalyst material. The substreams 26 are guided in a first pass 27 in straight tube segments from top to bottom through the furnace space 28, deflected through tube bends 30 and removed from the furnace space 28 from bottom to top in the second pass 31, likewise in straight tube segments, and combined in collector 33. Finally the gases are removed from the system as a synthesis gas stream through line 34.

The furnace space is heated in this exemplary embodiment by eight side wall burners 22, which are high-speed burners arranged in pairs distributed on four levels. The burners, which produce an intense turbulence in the furnace space atmosphere due to the great momentum of their off-gases, are supplied with combustion gas and air through lines 35 and 36. The turbulence and velocity of flow of the off-gases are additionally increased by the draw-off tube 37 which runs over almost the entire height and along the longitudinal axis of the furnace space 28 and limits the flow cross section for the off-gases. The off-gases are discharged from the reformer 24 through the line 38.

1-7. (canceled)

8. A method for endothermic catalytic reaction of a feedstream, wherein the feedstream is divided into at least two substreams, which are passed in parallel through reactor tubes arranged in a furnace space of a reactor, packed at least partially with a packing of catalyst material or a catalytically active structured packing or surface-coated with a catalytically active material on an inside at least partially, wherein each of the substreams crosses completely or partially through the furnace space in at least two passes, wherein directions of flow are in essentially opposite directions in two successive passes, wherein each of the substreams crosses through the furnace space in an interior of a reactor tube formed by straight, parallel tube segments that are connected with a connecting tube, and wherein the furnace space is heated by at least one burner in a manner that ensures intense circulation of a furnace space atmosphere.

9. The method according to claim 8, wherein the furnace space is heated by bottom burners and/or top burners and/or side wall burners.

10. The method according to claim 8, wherein turbulence is induced in off-gases with baffles and the off-gases are passed through the furnace space.

11. A device for endothermic catalytic conversion of a feedstream wherein the feedstream is divided into at least two substreams, which are passed in parallel through reactor tubes arranged in a furnace space of a reactor, packed at least partially with a packing of catalyst material or a catalytically active structured packing or surface-coated on an inside with a catalytically active material at least partially, wherein each of the reactor tubes is shaped in such a way that the substreams are passable entirely or partially through the furnace space in at least two passes, wherein directions of flow of two successive passes are essentially in opposite directions, wherein the reactor tubes have parallel areas essentially with a same length in an area of the furnace space passes with the parallel areas being formed by straight tube segments that are joined together by a connecting tube, and wherein the furnace space is equipped with at least one burner which ensures an intense circulation of a furnace space atmosphere.

12. The device according to claim 11, wherein the at least one burner is arranged on a bottom and/or on a top and/or on a side wall of the furnace space.

13. The device according to claim 11, wherein the at least one burner generates an off-gas which has a high exit momentum.

14. The device according to claim 11, wherein the furnace space contains a baffle for creating turbulence and guiding an off-gas generated by the at least one burner.

15. A method for endothermic catalytic reaction of a feedstream, comprising the steps of:
providing a feedstream to a reactor tube arranged in a furnace space of a reactor;
flowing the feedstream through the reactor tube in a first pass with a first direction of flow though the furnace space; and
flowing the feedstream through the reactor tube in a second pass with a second direction of flow though the furnace space;
wherein the first direction of flow is opposite to the second direction of flow.

16. The method according to claim 15, further comprising the step of restricting a flow cross-section of a combustion gas of a burner in the furnace space by a tube encircling the burner.

17. The method according to claim 16, further comprising the steps of increasing a velocity of flow and increasing a turbulence of the combustion gas by the tube.

18. The method according to claim 16, wherein the first pass occurs within the tube and wherein the second pass occurs outside of the tube.

19. The method according to claim 16, further comprising the steps of creating a circulation of the combustion gas within the furnace space by flowing the combustion gas from the burner through the tube, deflecting the combustion gas between a top of the furnace space and a top end of the tube, and then flowing the combustion gas from the top of the furnace space to a bottom of the furnace space on an outside of the tube.

20. The method according to claim 15, further comprising the step of restricting a flow cross-section of a combustion gas of a burner in the furnace space by a tube arranged centrally in the furnace space, wherein the burner is disposed in a side wall that defines the furnace space.

21. The method according to claim 20, further comprising the steps of increasing a velocity of flow and increasing a turbulence of the combustion gas by drawing off the combustion gas from the furnace space through the tube.

22. The method according to claim 20, wherein the first pass and the second pass occur outside of the tube.
